(19) United States
(12) Patent Application Publication
(10) Pub. No.: US 2021/0334865 A1
(43) Pub. Date: Oct. 28, 2021

(54) Used Car Pricing Based on Telematics Information

(71) Applicant: Allstate Insurance Company, Northbrook, IL (US)

(72) Inventor: Grady Irey, Des Plaines, IL (US)

(21) Appl. No.: 15/048,173

(22) Filed: Feb. 19, 2016

(51) Int. Cl. G06Q 30/02; G07C 5/08

(52) U.S. Cl. CPC G06Q 30/0283; G07C 5/08

(57) ABSTRACT

A driving data analysis and vehicle maintenance server may be configured to receive vehicle driving data corresponding to vehicle operation data of a vehicle, analyze the received vehicle driving data, determine a driving behavior associated with the vehicle, determine recommended vehicle maintenance and calculate a vehicle resale price for the vehicle. The recommended vehicle maintenance may be determined based on vehicle driving data received from the plurality of sensors over a lifetime of the vehicle.

### BACKGROUND

People and organizations, such as insurance providers, are interested in collecting vehicle telematics data. Vehicle telematics data includes various data from measurements related to a vehicle's operation. One example of telematics systems currently in use in automobiles are on-board diagnostics (OBD) systems. From early versions of OBD systems that included crude implementations of control for features such as fuel injection to more sophisticated and standardized OBD-I and OBD-II units, these units have served as an electronic gateway into the health of a vehicle. These systems have allowed users to monitor a wide variety of engine sensors and systems, including emissions control, coolant temperature, engine RPM, vehicle speed, timing advance, throttle position, and oxygen sensing, among other things.

Data obtained from OBD systems has been used for a variety of purposes, including maintenance, diagnosis and analysis. Because OBD systems may gather information that reflects how a driver uses a vehicle, these systems have also been used to assist in calculating insurable risk associated with a driver (e.g., based on factors such as how fast a particular driver generally operates a vehicle, location in which the vehicle is primarily used, and time of day in which the vehicle is generally operated).

### BRIEF SUMMARY

The following presents a simplified summary in order to provide a basic understanding of some aspects of the disclosure. The summary is not an extensive overview of the disclosure. It is neither intended to identify key or critical elements of the disclosure nor to delineate the scope of the disclosure. The following summary merely presents some concepts of the disclosure in a simplified form as a prelude to the description below.

Aspects of the disclosure may include a system including a plurality of vehicle operation sensors arranged on a vehicle and configured to monitor operation of the vehicle and a driving data analysis and vehicle pricing server including a processor, and at least one memory storing computer-executable instructions, which when executed by the processor, cause the driving data analysis and vehicle pricing server to receive vehicle driving data from the plurality of vehicle operation sensors, the vehicle driving data corresponding to vehicle operation data of the vehicle, analyze the received vehicle driving data, determine a driving behavior associated with the vehicle, based on the analysis of the vehicle driving data, and calculate a vehicle resale price for the vehicle, based on the determined driving behavior and vehicle driving data. In accordance with further aspects of the present disclosure, the vehicle driving data may be selected from the group consisting of engine speed, rate of acceleration, rate of deceleration, road conditions, locations that the vehicle has traveled, vehicle inspection histories, vehicle maintenance histories, average braking times, and combinations thereof. The resale price may calculated based on vehicle driving data received from the plurality of sensors over a lifetime of the vehicle. Alternatively, the resale price may be calculated based on vehicle driving data collected by the plurality of sensors over a predetermined period of time.

In accordance with further aspects of the present disclosure, determining a driving behavior associated with the vehicle may include determining that the vehicle exceeded a maximum deceleration rate at least a minimum number of times within a predetermined period of time and calculating a vehicle resale price for the vehicle may include reducing the at least one first vehicle price by a penalty amount. Alternatively, determining a driving behavior associated with the vehicle may include determining that the vehicle exceeded a maximum operation distance at least a minimum number of times within a predetermined period of time and calculating a vehicle resale price for the vehicle may include reducing the at least one first vehicle price by a penalty amount.

In accordance with further aspects of the present disclosure, the memory may further store computer-executable instructions, which when executed by the processor, cause the driving data analysis and vehicle pricing server to receive insurance provider vehicle price threshold data and determine whether the calculated vehicle resale price is within an insurance provider vehicle resale price threshold. The memory may additionally or alternatively further store computer-executable instructions, which when executed by the processor, cause the driving data analysis and vehicle pricing server to receive vehicle driving data from a telematics device located within the vehicle.

Aspects of the disclosure may include a computer-implemented method including receiving, by a driving analysis and vehicle pricing computing device, vehicle driving data corresponding to vehicle operation data of at least one vehicle, the vehicle operation data being received from a plurality of sensors arranged on the at least one vehicle and configured to monitor operation of the vehicle, analyzing, by the driving analysis and vehicle pricing computing device, the received vehicle driving data, determining, by the driving analysis and vehicle pricing computing device, a driving behavior associated with the at least one vehicle, based on the analysis of the vehicle driving data, and calculating a vehicle resale price for the at least one vehicle, based on the determined driving behavior and vehicle driving data. In accordance with further aspects of the present disclosure, the vehicle driving data may be selected from the group consisting of engine speed, rate of acceleration, rate of deceleration, road conditions, locations that the vehicle has traveled, vehicle inspection histories, vehicle maintenance histories, average braking times, and combinations thereof. In accordance with further aspects of the present disclosure, determining a driving behavior associated with the at least one vehicle may include determining that the at least one vehicle exceeded a maximum deceleration rate at least a minimum number of times within a predetermined period of time and calculating a vehicle resale price for the at least one vehicle includes reducing the at least one first vehicle price by a penalty amount.

In accordance with further aspects of the present disclosure, determining a driving behavior associated with the at least one vehicle may include determining that the at least one vehicle exceeded a maximum operation distance at least a minimum number of times within a predetermined period of time and calculating a vehicle resale price for the at least one vehicle includes reducing the at least one first vehicle price by a penalty amount. In accordance with further aspects of the present disclosure, the computer-implemented method may further include receiving, by the driving analysis and vehicle pricing computing device, vehicle resale price threshold data from an insurance provider server, determining, by the driving analysis and vehicle pricing computing device, whether the calculated vehicle resale price is within an insurance provider vehicle resale price threshold, and if the calculated vehicle resale price is within the insurance provider vehicle resale price threshold, a consumer agreeing to purchase the at least one vehicle.

Aspects of the disclosure may include a system including a plurality of vehicle operation sensors arranged on a vehicle and configured to monitor operation of the vehicle and a driving data analysis and vehicle maintenance server including a processor and at least one memory storing computer-executable instructions, which when executed by the processor, cause the driving data analysis and vehicle maintenance server to: receive vehicle driving data from the plurality of vehicle operation sensors, the vehicle driving data corresponding to vehicle operation data of the vehicle, analyze the received vehicle driving data, determine a driving behavior associated with the vehicle, based on the analysis of the vehicle driving data, determine recommended vehicle maintenance based on the determined driving behavior and vehicle driving data, and calculate a vehicle resale price for the vehicle, based on the determined vehicle maintenance and vehicle driving data. In accordance with further aspects of the present disclosure, the vehicle driving data may selected from the group consisting of engine speed, rate of acceleration, rate of deceleration, road conditions, locations that the vehicle has traveled, vehicle inspection histories, vehicle maintenance histories, average braking times, and combinations thereof. In accordance with further aspects of the present disclosure, the recommended vehicle maintenance may be determined based on vehicle driving data received from the plurality of sensors over a lifetime of the vehicle. The recommended vehicle maintenance may determined based on vehicle driving data collected by the plurality of sensors over a predetermined period of time. In accordance with further aspects of the present disclosure, determining a driving behavior associated with the vehicle may include determining that the vehicle exceeded a maximum deceleration rate at least a minimum number of times within a predetermined period of time. In accordance with further aspects of the present disclosure, determining a driving behavior associated with the vehicle may include determining that the vehicle exceeded a maximum operation distance at least a minimum number of times within a predetermined period of time. In accordance with further aspects of the present disclosure, the at least one memory may further store computer-executable instructions, which when executed by the processor, cause the driving data analysis and vehicle maintenance server to provide a time period in which the recommended vehicle maintenance should be completed.

The details of these and other aspects of the disclosure are set forth in the accompanying drawings and description below. Other features and advantages of aspects of the disclosure will be apparent from the description and drawings.

### BRIEF DESCRIPTION OF THE DRAWINGS

Some embodiments are illustrated by way of example, and not by way of limitation, in the figures of the accompanying drawings. Aspects of the disclosure may be implemented in certain parts, steps, and embodiments that will be described in detail in the following description and illustrated in the accompanying drawings in which like reference numerals indicate similar elements. It will be appreciated with the benefit of this disclosure that the steps illustrated in the accompanying figures may be performed in other than the recited order and that one or more of the steps may be optional. It will also be appreciated with the benefit of this disclosure that one or more components illustrated in the accompanying figures may be positioned in other than the disclosed arrangement and that one or more of the components illustrated may be optional.

FIG. 1 illustrates a network environment and computing systems that may be used to implement one or more aspects of the disclosure.

FIG. 2 is a diagram illustrating various components and devices of a driving analysis and vehicle pricing system, according to one or more aspects of the disclosure.

FIG. 3 is a flow diagram illustrating an example method of analyzing vehicle driving data, determining driving behaviors, and calculating vehicle grades and/or price adjustments, according to one or more aspects of the disclosure.

FIG. 4 is a diagram illustrating various components and devices of a driving analysis and vehicle maintenance system, according to one or more aspects of the disclosure.

FIG. 5 is a flow diagram illustrating an example method of determining whether vehicle maintenance is recommended and calculating vehicle grades and/or price adjustments, according to one or more aspects of the disclosure.

### DETAILED DESCRIPTION

In the following description of the various embodiments, reference is made to the accompanying drawings, which form a part hereof, and in which is shown by way of illustration, various embodiments of the disclosure that may be practiced. It is to be understood that other embodiments may be utilized.

As will be appreciated by one of skill in the art upon reading the following disclosure, various aspects described herein may be embodied as a method, a computer system, or a computer program product. Accordingly, those aspects may take the form of an entirely hardware embodiment, an entirely software embodiment or an embodiment combining software and hardware aspects. Furthermore, such aspects may take the form of a computer program product stored by one or more computer-readable storage media having computer-readable program code, or instructions, embodied in or on the storage media. Any suitable computer readable storage media may be utilized, including hard disks, CD-ROMs, optical storage devices, magnetic storage devices, and/or any combination thereof. In addition, various signals representing data or events as described herein may be transferred between a source and a destination in the form of electromagnetic waves traveling through signal-conducting media such as metal wires, optical fibers, and/or wireless transmission media (e.g., air and/or space).

It is to be understood that the phraseology and terminology used herein are for the purpose of description and should not be regarded as limiting. Rather, the phrases and terms used herein are to be given their broadest interpretation and meaning. The use of “including” and “comprising” and variations thereof is meant to encompass the items listed thereafter and equivalents thereof, as well as additional items and equivalents thereof. A user, as used in this description, refers to an individual or group of individuals. In certain embodiments, a family, group of friends or co-workers, or other group that shares a vehicle may be users of the same driving analysis system. The user may or may not hold a fully qualified driver's license, may or may not own/lease/rent the vehicle, and may or may not hold an insurance policy. As used herein, a resale price may include, for instance, a suggested, determined, and/or calculated price for a used or pre-owned vehicle.

In accordance with various aspects of the disclosure, methods, systems, computer-readable media, software, and apparatuses are disclosed that provide a driving analysis and vehicle pricing system for collecting, evaluating, and using vehicle telematics data for determining and/or adjusting (e.g., decreasing and/or increasing) the resale value of a used vehicle. In certain aspects, the arrangements described herein may set or suggest prices for a used vehicle based on the lifetime of, or recent years of, telematics data collected from the vehicle. Based on the past telematics information, the system can provide a price and/or a grade for the vehicle. In some examples, the arrangements may further include an entity (e.g., an insurance provider) agreeing to purchase the vehicle for the price provided, based on the past telematics information for the vehicle.

In accordance with additional or alternative embodiments, methods, systems, computer-readable media, software, and apparatuses are disclosed that provide a driving analysis and vehicle maintenance system for collecting, evaluating, and using vehicle telematics data for predicting and/or recommending vehicle maintenance. According to various aspects, the arrangements may alert a user as to maintenance needed or recommended for the vehicle and/or may include a time frame in which the maintenance is recommended to be completed. For instance, the system may determine, based on past telematics information, whether the user should seek maintenance (e.g., tires, oil, shocks, brakes, etc.) before or after the time period suggested by the vehicle manufacturer.

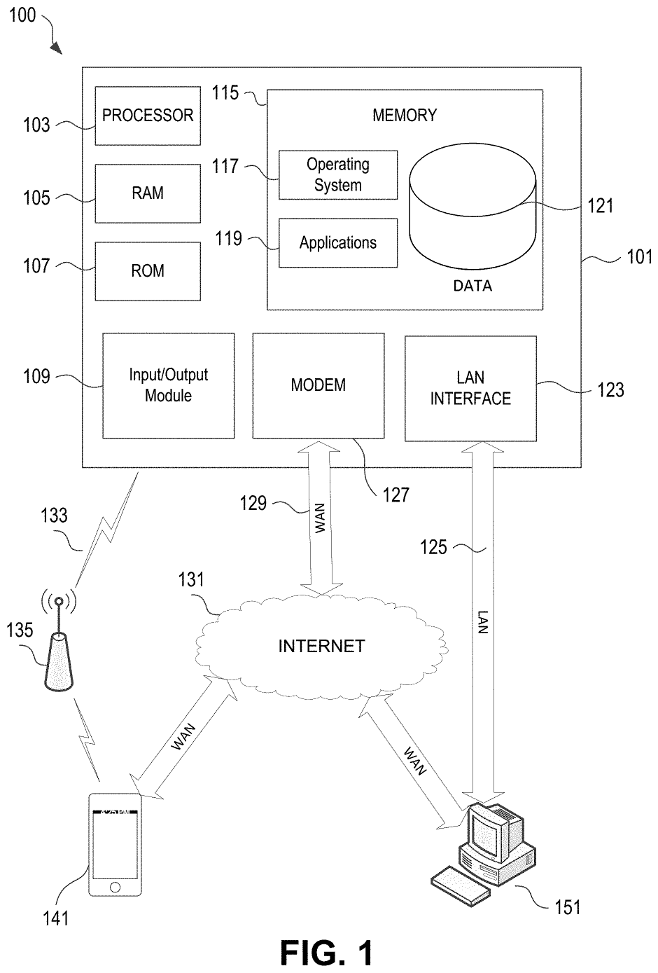

FIG. 1 illustrates a block diagram of a computing device in a driving analysis system 100 that may be used according to one or more illustrative embodiments of the disclosure. In some examples, the computing device 101 may be a telematics device. In other examples, the computing device may be a device in communication with one or more telematics devices or other devices in communication with a telematics device of a vehicle. The computing device 101 may have a processor 103 for controlling overall operation of the device 101 and its associated components, including RAM 105, ROM 107, input/output module 109, and memory 115. The computing device 101, along with one or more additional devices (e.g., terminals 141, 151) may correspond to any of multiple systems or devices, such as driving analysis and vehicle pricing computing devices or systems, configured as described herein for transmitting and receiving vehicle performance and condition data (e.g., telematics data), analyzing vehicle driving data, identifying driving behaviors and grading a vehicle based on past telematics data and/or determining and/or adjusting (e.g., decreasing and/or increasing) the resale value of a used vehicle based on the past telematics data. Additionally or alternatively, the computing device 101, along with one or more additional devices (e.g., terminals 141, 151) may correspond to driving analysis and vehicle maintenance computing devices or systems, configured as described herein for collecting, evaluating, and using vehicle telematics data for predicting and/or recommending vehicle maintenance.

Input/Output (I/O) 109 may include a microphone, keypad, touch screen, and/or stylus through which a user of the computing device 101 may provide input, and may also include one or more of a speaker for providing audio output and a video display device for providing textual, audiovisual and/or graphical output. Software may be stored within memory 115 and/or storage to provide instructions to processor 103 for enabling device 101 to perform various functions. For example, memory 115 may store software used by the device 101, such as an operating system 117, application programs 119, and an associated internal database 121. Processor 103 and its associated components may allow the computing device 101 to execute a series of computer-readable instructions to transmit or receive vehicle driving data, analyze driving data, identify driving behaviors, and determine or adjust (e.g., decrease and/or increase) the resale value of a used car based on the telematics data. Additionally or alternatively, processor 103 and its associated components may allow the computing device 101 to execute a series of computer-readable instructions to collect, evaluate, and use vehicle telematics data to predict and/or recommend vehicle maintenance.

The computing device 101 may operate in a networked environment 100 supporting connections to one or more remote computers, such as terminals/devices 141 and 151. Computing device 101, and related terminals/devices 141 and 151, may include devices installed in vehicles, mobile devices that may travel within vehicles, and/or devices outside of vehicles that are configured to receive and process vehicle and driving data. Thus, the computing device 101 and terminals/devices 141 and 151 may each include personal computers (e.g., laptop, desktop, tablet computers and the like), servers (e.g., web servers, database servers, etc.), vehicle-based devices (e.g., on-board vehicle computers, telematics devices, etc.), or mobile communication devices (e.g., mobile phones, portable computing devices, and the like), and may include some or all of the elements described above with respect to the computing device 101. The network connections depicted in FIG. 1 include a local area network (LAN) 125 and a wide area network (WAN) 129, and a wireless telecommunications network 133, but may also include other networks. When used in a LAN networking environment, the computing device 101 may be connected to the LAN 125 through a network interface or adapter 123. When used in a WAN networking environment, the device 101 may include a modem 127 or other means for establishing communications over the WAN 129, such as network 131 (e.g., the Internet). When used in a wireless telecommunications network 133, the device 101 may include one or more transceivers, digital signal processors, and additional circuitry and software for communicating with wireless computing devices 141 (e.g., mobile phones, short-range vehicle communication systems, vehicle telematics devices, etc.) via one or more network devices 135 (e.g., base transceiver stations) in the wireless network 133.

It will be appreciated that the network connections shown are illustrative and other means of establishing a communications link between the computers may be used. The existence of any of various network protocols such as TCP/IP, Ethernet, FTP, HTTP and the like, and of various wireless communication technologies such as GSM, CDMA, WiFi, and WiMAX, is presumed, and the various computing devices, driving analysis and vehicle pricing system components and driving analysis and vehicle maintenance system components described herein may be configured to communicate using any of these network protocols or technologies.

Aspects of the disclosure may be described in the general context of computer-executable instructions, such as program modules, being executed by a computer. Generally, program modules include routines, programs, objects, components, data structures, etc. that perform particular tasks or implement particular data types. The disclosure may also be practiced in distributed computing environments where tasks are performed by remote processing devices that are linked through a communications network. In a distributed computing environment, program modules may be located in both local and remote computer storage media including memory storage devices.

Additionally, one or more application programs 119 used by the computing device 101 may include computer executable instructions (e.g., vehicle telematics analysis programs, driving behavior analysis programs, vehicle grade algorithms, vehicle resale value algorithms, vehicle maintenance algorithms, etc.) for transmitting, receiving and/or collecting vehicle driving data, evaluating and/or analyzing vehicle driving data, determining driving behaviors, calculating vehicle grades, calculating vehicle resale price, predicting and/or recommending vehicle maintenance, and/or performing other related functions as described herein.

As used herein, a vehicle grade may refer to a measurement of driving behavior history (based on vehicle driving data), vehicle maintenance history, vehicle accident and/or insurance claim history and other vehicle information indicative of vehicle value. A vehicle grade may be a rating generated by an insurance provider, financial institution, or other organization. For example, an insurance provider server may periodically calculate (e.g., determine and/or adjust) vehicle grades for one or more vehicles of the insurance provider's customers, and may use the vehicle grades to perform insurance analyses and determinations (e.g., with regard to resale value, insurance coverage, premiums and deductibles, rewards, etc.). As discussed below, a vehicle grade may be calculated based on driving data collected by vehicle sensor(s) and/or telematics device(s).

Vehicle grades may be classified using a relatively simple scale (e.g., binary, numerical, letter, etc.). If a vehicle is repeatedly hard braking, swerving, speeding, weaving, tailgating, racing, stored/parked in a potentially vehicle-damaging manner (e.g., unsheltered, for extended periods of time, etc.), driven in inclement weather conditions (e.g., rain, snow, sleet, fog, hail, exceedingly high external temperature, exceedingly low external temperature, etc.), driven along potentially vehicle-damaging routes (e.g., gravel roads, rocky terrain, bumpy terrain, congested city roads, off-road, etc.) or engaging in other negative driving behaviors, then the vehicle may be assigned a low grade (e.g., “Bad,” 1 out of 5, “F,” etc.). Likewise, if certain vehicle conditions (e.g., tire pressure, fluid levels, etc.) are often less than optimal, as determined from vehicle telematics data, then the vehicle may also be assigned a low grade. In contrast, if a vehicle is obeying the speed limit and traffic laws, following at a safe distance, yielding, practicing defensive avoidance, avoiding negative driving behaviors, and engaging in other positive driving behaviors, then the vehicle may be assigned a high grade (e.g., “Good,” 5 out of 5, “A,” etc.). Similarly, if certain vehicle conditions (e.g., tire pressure, fluid levels, etc.) meet or exceed optimal levels, as determined from vehicle telematics data, then the vehicle may also be assigned a high grade. In certain instances, vehicle data may be aggregated over a predetermined period of time in order to obtain more data and/or more accurate data. In some examples, additional information may be used to calculate vehicle grades and/or resale prices in order to increase the accuracy of the vehicle grades and/or resale prices. For example, driving analysis and vehicle pricing module 214 of the vehicle 210 may use additional vehicle identifying information, such as the vehicle's make, model, year, VIN, insurance information, driver information, and/or owner information to perform a more accurate calculation, or may transmit this information to the driving analysis and vehicle pricing server 250, which may perform the grade and/or resale price calculation(s) after accessing driving records, insurance records, maintenance records, and any other available information regarding the vehicle or drivers of the vehicle.

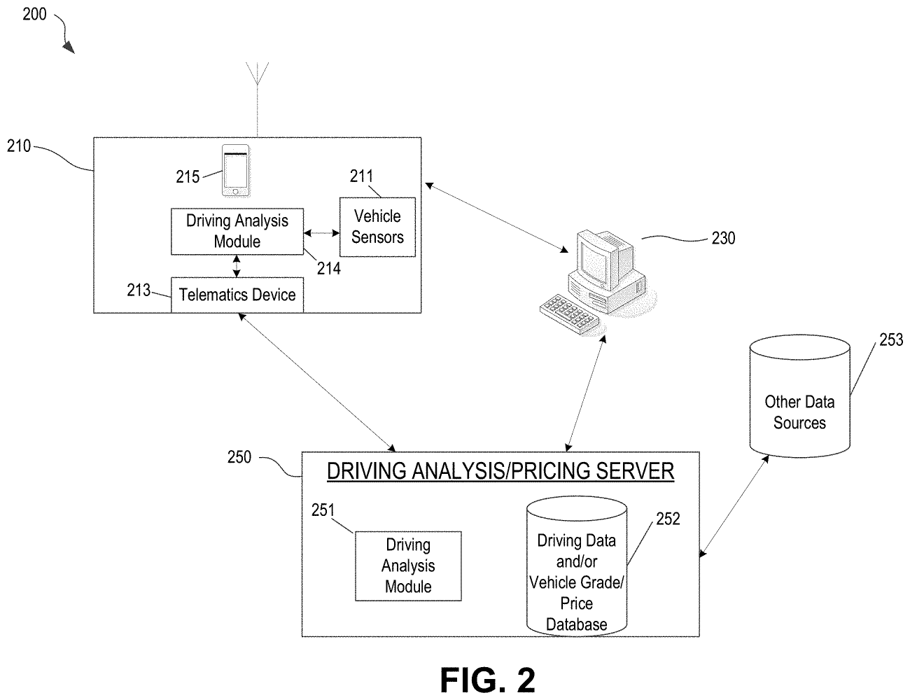

FIG. 2 is a diagram of an illustrative driving analysis and vehicle pricing system 200 including a vehicle 210, a driving analysis and vehicle pricing server 250, and additional related components. Each component shown in FIG. 2 may be implemented in hardware, software, or a combination of the two. Additionally, each component of the driving analysis and vehicle pricing system 200 may include a computing device (or system) having some or all of the structural components described above for computing device 101.

Vehicle 210 in the driving analysis and vehicle pricing system 200 may be, for example, an automobile, motorcycle, scooter, bus, recreational vehicle, boat, airplane or other vehicle for which vehicle performance and condition data may be analyzed and for which vehicle grades and resale prices may be calculated. The vehicle 210 may or may not be an insurance provider customer and/or may or may not be a subscriber to the insurance provider's telematics program. In some embodiments, the user associated with vehicle 210 may be a customer of the insurance provider and a subscriber to the insurance provider's telematics program. In other embodiments, the user associated with vehicle 210 is a subscriber to the insurance provider's telematics program but is not a customer of the insurance provider (e.g., does not have an insurance policy with the insurance provider). The vehicle 210 includes vehicle operation sensors 211 capable of detecting and recording various conditions at the vehicle and operational parameters of the vehicle. For example, sensors 211 may detect and store data corresponding to the vehicle's location (e.g., GPS coordinates), speed and direction, rates of acceleration or braking, and specific instances of sudden acceleration, braking, and swerving. Sensors 211 also may detect and store data received from the vehicle's 210 internal systems, such as impact to the body of the vehicle, air bag deployment, headlights usage, brake light operation, door opening and closing, door locking and unlocking, cruise control usage, hazard lights usage, windshield wiper usage, horn usage, turn signal usage, seat belt usage, phone and radio usage within the vehicle, maintenance performed on the vehicle, and other data collected by the vehicle's computer systems.

Additional sensors 211 may detect and store the external driving conditions, for example, external temperature, rain, snow, light levels, and sun position for driver visibility. For example, external cameras and proximity sensors 211 may detect other nearby vehicles, traffic levels, road conditions, traffic obstructions, animals, cyclists, pedestrians, and other conditions that may factor into a driving event data analysis. Sensors 211 also may detect and store data relating to moving violations and the observance of traffic signals and signs by the vehicle 210. Additional sensors 211 may detect and store data relating to the maintenance of the vehicle 210, such as the engine status, oil level, engine coolant temperature, odometer reading, the level of fuel in the fuel tank, engine revolutions per minute (RPMs), and/or tire pressure.

Vehicles sensors 211 also may include cameras and/or proximity sensors capable of recording additional conditions inside or outside of the vehicle 210. For example, internal cameras may detect conditions such as the number of the passengers, types of passengers (e.g. adults, children, teenagers, pets, etc.) and identity of passengers in the vehicles, and potential sources of driver distraction within the vehicle (e.g., pets, phone usage, unsecured objects in the vehicle, etc.). Sensors 211 also may be configured to collect data regarding a driver's movements or the condition of a driver. For example, vehicle 210 may include sensors that monitor a driver's movements, such as the driver's eye position and/or head position, etc. Additional sensors 211 may collect data regarding the physical or mental state of the driver, such as fatigue or intoxication. The condition of the driver may be determined through the movements of the driver or through other sensors (e.g., sensors that detect alcohol content in the air or blood alcohol content of the driver, such as a breathalyzer).

Certain vehicle sensors 211 also may collect information regarding the driver's route choice, whether the driver follows a given route, and to classify the type of trip (e.g. commute, errand, new route, etc.). In certain embodiments, sensors and/or cameras 211 may determine when and how often the vehicle 210 stays in a single lane or strays into other lanes. Global Positioning System (GPS) locational sensors positioned inside the vehicle 210, and/or locational sensors or devices external to the vehicle 210 may be used to determine the route, lane position, and other vehicle position/location data.

The data collected by vehicle sensors 211 may be stored and/or analyzed within the respective vehicle 210, and/or may be transmitted to one or more external devices. For example, as shown in FIG. 2, sensor data may be transmitted via a telematics device 213 to one or more remote computing devices, such as driving analysis and vehicle pricing server 250.

As shown in FIG. 2, the data collected by vehicle sensors 211 may be transmitted to a driving analysis and vehicle pricing server 250, and one or more additional external servers and devices via a telematics device 213. Telematics device 213 may be a computing device containing many or all of the hardware/software components as the computing device 101 depicted in FIG. 1. As discussed above, the telematics device 213 may receive vehicle operation data and driving data from vehicle sensors 211, and may transmit the data to one or more external computer systems (e.g., driving analysis and vehicle pricing server 250 of an insurance provider, financial institution, or other entity) over a wireless transmission network. Telematics device 213 also may be configured to detect or determine additional types of data relating to real-time driving and the condition of the vehicle 210. In certain embodiments, the telematics device 213 may contain or may be integral with one or more of the vehicle sensors 211. The telematics device 213 also may store the type of its respective vehicle 210, for example, the make, model, trim (or sub-model), year, and/or engine specifications, as well as other information such as vehicle owner or driver information, insurance information, and financing information for the vehicle 210.

In the embodiment shown in FIG. 2, telematics device 213 may receive vehicle performance and condition data from vehicle sensors 211, and may transmit the data to a driving analysis and vehicle pricing server 250. However, in other embodiments, one or more of the vehicle sensors 211 may be configured to transmit data directly to a driving analysis and vehicle pricing server 250 without using a telematics device. For instance, telematics device 213 may be configured to receive and transmit data from certain vehicle sensors 211, while other sensors may be configured to directly transmit data to a driving analysis and vehicle pricing server 250 without using the telematics device 213. Thus, telematics device 213 may be optional in certain embodiments.

In certain embodiments, mobile computing device 215 within the vehicle 210 may be used to collect vehicle performance and condition data and/or to receive vehicle performance and condition data from sensors 211, and then to transmit the vehicle performance and condition data to the driving analysis and vehicle pricing server 250 and other external computing devices. Mobile computing device 215 may be, for example, a mobile phone, personal digital assistant (PDA), or tablet computer of the drivers or passengers of vehicle 210. Software applications executing on mobile device 215 may be configured to detect certain driving data independently and/or may communicate with vehicle sensors 211 to receive additional driving data. For example, mobile device 215 equipped with GPS functionality may determine vehicle location, speed, direction and other basic driving data without needing to communicate with the vehicle sensors 211, or any vehicle system. In other examples, software on the mobile device 215 may be configured to receive some or all of the driving data collected by vehicle sensors 211.

When mobile computing device 215 within the vehicle 210 is used to detect vehicle performance and condition data and/or to receive vehicle performance and condition data from vehicle sensors 211, the mobile computing device 215 may store, analyze, and/or transmit the vehicle performance and condition data to one or more other devices. For example, mobile computing device 215 may transmit vehicle performance and condition data directly to one or more driving analysis and vehicle pricing servers 250, and thus may be used in conjunction with or instead of telematics device 213. Moreover, the processing components of the mobile computing device 215 may be used to analyze vehicle driving data, determine driving behaviors, calculate vehicle grades and/or resale prices, and perform other related functions. Therefore, in certain embodiments, mobile computing device 215 may be used in conjunction with, or in place of, the driving analysis and vehicle pricing module 214.

Vehicle 210 may include driving analysis and vehicle pricing module 214, which may be a separate computing device or may be integrated into one or more other components within the vehicle 210, such as the telematics device 213, or the internal computing systems of vehicle 210. In some embodiments, vehicle 210 does not include a driving analysis and vehicle pricing module 214. As discussed above, driving analysis and vehicle pricing module 214 also may be implemented by computing devices independent from the vehicle 210, such as mobile computing device 215 of the drivers or passengers, or one or more separate computer systems 230 (e.g., a user's home or office computer). In any of these examples, the driving analysis and vehicle pricing module 214 may contain some or all of the hardware/software components of the telematics device 101 depicted in FIG. 1. Further, in certain implementations, the functionality of the driving analysis and vehicle pricing module 214, such as storing and analyzing vehicle driving data, determining driving behaviors, and calculating vehicle grades and/or resale prices, may be performed in a central driving analysis and vehicle pricing server 250 rather than by the vehicle 210. In such implementations, the vehicle 210 might only collect and transmit vehicle performance and condition data to a driving analysis and vehicle pricing server 250, and thus the vehicle-based driving analysis and vehicle pricing module 214 may be optional.

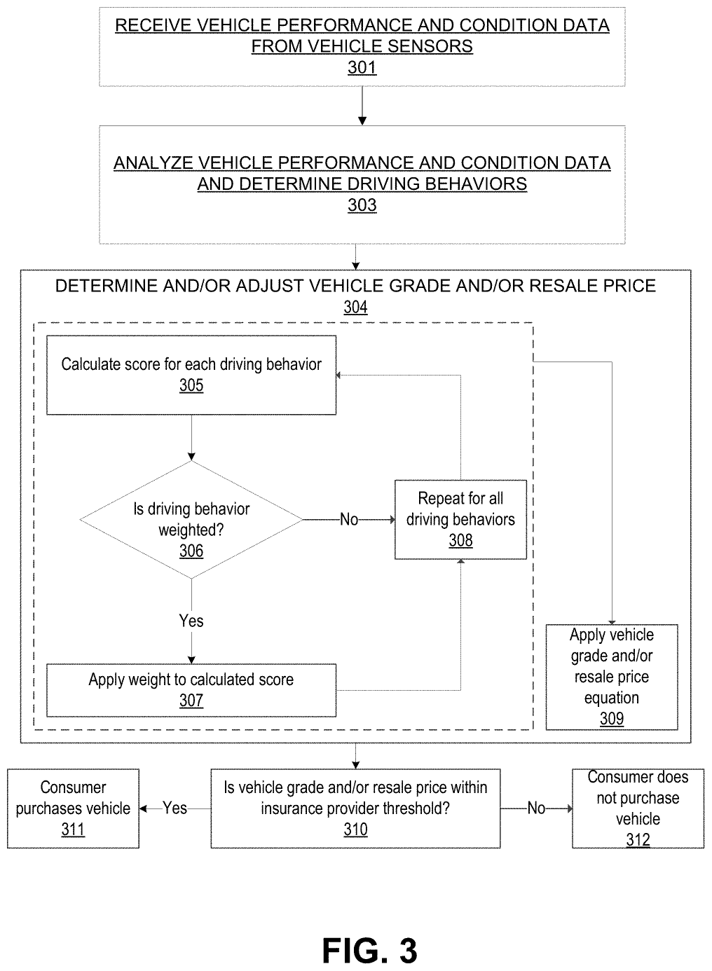

Driving analysis and vehicle pricing module 214 may be implemented in hardware and/or software configured to receive vehicle performance and condition data from vehicle sensors 211, telematics device 213, and/or other driving data sources. After receiving the vehicle driving data, driving analysis and vehicle pricing module 214 may perform a set of functions to analyze the driving data, determine driving behaviors, and calculate vehicle grades and/or prices. For example, the driving analysis and vehicle pricing module 214 may include one or more driving behavior analysis, vehicle grade and/or vehicle price calculation algorithms, which may be executed by software running on generic or specialized hardware within the driving analysis and vehicle pricing module 214. The driving analysis and vehicle pricing module 214 in vehicle 210 may use the vehicle performance and condition data received from that vehicle's sensors 211 to determine driving behaviors and calculate vehicle grades and/or prices applicable to vehicle 210. Within the driving analysis and vehicle pricing module 214, a vehicle grade/price calculation function may use the results of the driving analysis and vehicle pricing performed by the module 214 to calculate/adjust vehicle grades and/or prices for vehicle 210 based on determined driving behaviors. Further descriptions and examples of the algorithms, functions, and analyses that may be executed by the driving analysis and vehicle pricing module 214 are described below in reference to FIG. 3.

The system 200 also may include a driving analysis and vehicle pricing server 250, containing some or all of the hardware/software components as the computing device 101 depicted in FIG. 1. The driving analysis and vehicle pricing server 250 may include hardware, software, and network components to receive vehicle performance and condition data from one or more vehicles 210, and other data sources 253. The driving analysis and vehicle pricing server 250 may include a driving data and vehicle grade and/or price database 252 and driving analysis and vehicle pricing module 251 to respectively store and analyze driving data received from vehicles and other data sources 253 (e.g., insurance records, including policy information, vehicle accident and/or claim history, etc.; vehicle maintenance records; driving records; etc.). The driving analysis and vehicle pricing server 250 may initiate communication with and/or retrieve driving data from vehicle 210 wirelessly via telematics device 213, mobile device 215, or by way of separate computing systems (e.g., computer 230) over one or more computer networks (e.g., the Internet). Additionally, the driving analysis and vehicle pricing server 250 may receive additional data relevant to driving behavior determinations and vehicle grade/price calculations from other non-vehicle data sources, such as external traffic databases containing traffic data (e.g., amounts of traffic, average driving speed, traffic speed distribution, and numbers and types of accidents, etc.) at various times and locations, external weather databases containing weather data (e.g., rain, snow, sleet, and hail amounts, temperatures, wind, road conditions, visibility, etc.) at various times and locations, and other external data sources containing driving hazard data (e.g., road hazards, traffic accidents, downed trees, power outages, road construction zones, school zones, and natural disasters, etc.).

Data stored in the driving data and vehicle grade and/or price database 252 may be organized in any of several different manners. For example, a table in driving data and vehicle grade and/or price database 252 may contain all of the vehicle operation data for a specific vehicle 210, similar to a vehicle event log. Other tables in the driving data and vehicle grade and/or price database 252 may store certain types of data for multiple vehicles. For instance, tables may store specific driving behaviors and interactions (e.g., accidents, tailgating, cutting-off, yielding, racing, defensive avoidances, etc.) for multiples vehicles. Vehicle performance and condition data may also be organized by time and/or place, so that the driving behaviors or interactions between multiples vehicle may be stored or grouped by time and location.

The driving analysis and vehicle pricing module 251 within the driving analysis and vehicle pricing server 250 may be configured to retrieve data from the driving data and vehicle grade and/or price database 252, or may receive driving data directly from vehicle 210 or other data sources 253, and may perform driving data analyses, driving behavior determinations, vehicle grade and/or price calculations, and other related functions. The functions performed by the driving analysis and vehicle pricing module 251 may be similar to those of driving analysis and vehicle pricing module 214, and further descriptions and examples of the algorithms, functions, and analyses that may be executed by the driving analysis and vehicle pricing module 251 are described below in reference to FIG. 3.

In various examples, the driving data analyses, driving behavior determinations, and vehicle grade and/or price calculations may be performed entirely in the driving analysis and vehicle pricing module 251 of the driving analysis and vehicle pricing server 250 (in which case driving analysis and vehicle pricing module 214 might not be implemented in vehicle 210), or may be performed entirely in the vehicle-based driving analysis and vehicle pricing module 214 (in which case the driving analysis and vehicle pricing module 251 and/or the driving analysis and vehicle pricing server 250 might not be implemented). In other examples, certain driving data analyses may be performed by vehicle-based driving analysis and vehicle pricing module 214, while other driving data analyses are performed by the driving analysis and vehicle pricing module 251 at the driving analysis and vehicle pricing server 250. For example, a vehicle-based driving analysis and vehicle pricing module 214 may continuously receive and analyze driving data from nearby vehicles to determine certain driving behaviors (e.g., tailgating, cutting-off, yielding, etc.) so that large amounts of driving data need not be transmitted to the driving analysis and vehicle pricing server 250. However, after a positive or negative driving behavior is determined by the vehicle-based driving analysis and vehicle pricing module 214, the behavior may be transmitted to the server 250, and the driving analysis and vehicle pricing module 251 may determine if a vehicle grade and/or price calculation should be updated based on the determined driving behavior.

FIG. 3 is a flow diagram illustrating an example method of performing driving behavior determinations and vehicle grade and/or price calculations based on analyses of vehicle performance and condition data received from, for example, vehicle sensors 211 and/or telematics device 213. This example method may be performed by one or more computing devices in a driving analysis and vehicle pricing system, such as vehicle-based driving analysis and vehicle pricing module 214, a driving analysis and vehicle pricing module 251 of a driving analysis and vehicle pricing server 250, user mobile computing device 215, and/or other computer systems.

The steps shown in FIG. 3 describe performing an analysis to determine driving behaviors of vehicle 210, calculating or adjusting vehicle 210 grades and/or resale prices based on the determined driving behaviors, determining whether or not the vehicle grade and/or resale price is within an insurance provider threshold, and, if the vehicle grade and/or resale price is within the insurance provider threshold, the insurance provider purchasing the vehicle 210. If the vehicle grade and/or resale price is outside the insurance provider threshold, the insurance provider does not purchase the vehicle 210. As described above in reference to FIG. 2, the vehicle 210 may or may not be an insurance provider customer and/or may or may not be a subscriber to the insurance provider's telematics program. In some embodiments, the vehicle 210 is a customer of the insurance provider and a subscriber to the insurance provider's telematics program. In other variations, the vehicle 210 is a subscriber to the insurance company's telematics program and/or not a customer of the insurance provider. Driving behaviors may include any number of identifiable events indicative of how a driver or drivers operate and maintain the vehicle 210, including negative behaviors such as hard braking, swerving, speeding, weaving, tailgating, cutting-off, brake-checking, racing, storing and/or parking the vehicle in a potentially vehicle-damaging manner (e.g., unsheltered, for extended periods of time, etc.), driving in inclement weather conditions (e.g., rain, snow, sleet, fog, hail, exceedingly high external temperature, exceedingly low external temperature, etc.), operating the vehicle under less than optimal vehicle conditions (e.g., tire pressure, fluid levels, etc.), and driving along potentially vehicle-damaging routes (e.g., gravel roads, rocky terrain, bumpy terrain, congested city roads, off-road, etc.), or positive behaviors such as yielding, avoiding negative driving behaviors, and meeting or exceeding optimal vehicle conditions (e.g., tire pressure, fluid levels, etc.). Occurrences of negative driving behaviors may indicate a potential decrease in vehicle grade and/or resale value, while occurrences of positive driving behaviors may indicate a potential increase in vehicle grade and/or resale value.

In step 301, vehicle performance and condition data may be received for a vehicle 210, corresponding to data from the vehicle's sensors 211, vehicle maintenance record databases, insurance record databases, external weather databases, external traffic databases, external driving hazards database and/or other vehicle data indicative of vehicle value. As described above in reference to FIG. 2, a driving analysis and vehicle pricing module 214 within vehicle 210 may receive and store vehicle performance and condition data from the vehicle's internal computer systems and any combination of the vehicle's sensors 211. The data received in step 301 may include, for example, the location, speed, and direction of the vehicle 210, object proximity data from the vehicle's external cameras and proximity sensors, the vehicle's make, model, year, VIN, driver information, insurance records (e.g., policy information, vehicle accident and/or claim history, etc.), maintenance records, the typical weather conditions (e.g., temperature, snow fall, rain fall, humidity, etc.) in the locations where the vehicle is driven, driving hazard data (e.g., road hazards, road construction zones, natural disasters, etc.) in the locations where the vehicle is driven, traffic data (e.g., amounts of traffic, average driving speed, traffic speed distribution, and numbers and types of accidents, etc.) in the locations where the vehicle is driven, vehicle condition data (e.g., wear on the tires, brakes, shocks, belts, lamps, etc.; vehicle body condition, etc.), and data from the vehicle's various systems used to determine if the vehicle 210 is braking, accelerating, decelerating or turning, etc., and to determine the status of the vehicle's user-operated controls (e.g., head lights, turn signals, hazard lights, radio, phone, etc.), along with any other data indicative of vehicle value. The vehicle performance and condition data received for vehicle 210 in step 301 may include data with respect to one driver of the vehicle (e.g., the primary driver of the vehicle) or for multiple drivers of the vehicle. In certain embodiments, the vehicle 210 may be configured to identify different drivers. According to various embodiments, the vehicle performance and condition data received for vehicle 210 in step 301 may include data received over the entire lifetime of the vehicle. In other embodiments, the data received for vehicle 210 in step 301 includes data for a specific predetermined time period (e.g., from the last year, last 5 years, etc.).

In step 303, the vehicle performance and condition data received in step 301 may be analyzed, and driving behaviors indicative of the condition of the vehicle may be determined for the vehicle 210 based on the driving data. For example, a driving analysis and vehicle pricing module 214 in a vehicle 210 may analyze the vehicle performance and condition data to identify any of the driving behaviors discussed herein (e.g., hard-braking, swerving). In certain embodiments, step 303 also includes an analysis of the insurance data (e.g., insurance claim information) and/or vehicle maintenance data to determine the condition of the vehicle 210. In certain aspects, the driving analysis and vehicle pricing module 214 may compare the wear of certain vehicle parts (e.g., tires, brakes, shocks, belts, lamps, etc.) to historical data from an insurance provider which identifies typical wear for the make, model, year, part, etc. of vehicle 210.

Driving behaviors indicative of the condition of the vehicle may be defined as one or more driving events which may affect the value and/or grade of the vehicle. A driving event, as determined from the vehicle driving data, may be based on the speed, acceleration, braking, turning, distance to other vehicles, seat belt usage, turn signal usage, and other vehicle telematics data collected from the vehicle 210. Thus, it will be appreciated that a variety of different driving behaviors may be defined based on a variety of different driving events. Further, a driving behavior may be defined in terms of distance travelled (e.g., one hundred miles) and/or time elapsed (e.g., one hour) during a trip (e.g., a period of time starting when the vehicle 210 is turned on and ending when the vehicle 210 is turned off). For example, a positive driving behavior based in part on speed may be a trip including 1 hour of highway driving within 5 mph of the prescribed speed limit. An example positive driving behavior based in part on braking or deceleration may be a trip including thirty minutes of city driving without occurrences of hard braking (e.g., deceleration of 7 mph/s or greater, etc.). An example negative driving behavior based in part on braking or deceleration may be a trip including thirty minutes of city driving with one or more occurrences of hard braking (e.g., deceleration of 7 mph/s or greater, etc.). An example positive driving behavior based in part on acceleration may be a trip including 30 minutes of highway driving without occurrences of fast acceleration (e.g., acceleration of 10 mph/s or greater, etc.). An example negative driving behavior based in part on acceleration may be a trip including 30 minutes of highway driving with one or more occurrences of fast acceleration (e.g., acceleration of 10 mph/s or greater, etc.). An example positive driving behavior based in part on turning may be a trip including fifty miles of driving with only soft turns (e.g., angle of turn greater than 90°, controlled turns, etc.). Another example positive driving behavior may be activating a turn signal at least hundred feet before initiating each turn of the trip. Driving behavior may also be based in part on particular driving conditions. For example, a positive driving behavior may be driving at least 10 mph below the speed limit during periods of the trip including inclement or severe weather (e.g., rain, snow, fog, etc.). It will be appreciated that additional or alternative driving behaviors may be selectively defined and implemented to encourage driving a vehicle in a manner which retains the most vehicle value.

In step 303, the driving analysis and vehicle pricing module 214 may determine whether a particular driving behavior was exhibited in the vehicle performance and condition data analysis results. For example, where a driving behavior is based on maintaining an average speed below 50 mph during a trip, the driving analysis and vehicle pricing module 214 may determine whether the vehicle performance and condition data analysis results for a particular trip reflected an average speed below 50 mph by comparing the average speed of the trip with the 50 mph limit. In some examples, the vehicle performance and condition data analysis results may include overall trip metrics (e.g., minimum/maximum/average speed, number of hard brakes, total miles traveled, etc.), such that the driving analysis and vehicle pricing module 214 may compare the metrics to the requirements of a particular driving behavior. However, in other examples, the driving analysis and vehicle pricing module 214 may need to derive one or more trip metrics in order to make a determination as to whether a user engaged in a particular driving behavior. For example, where a driving behavior involves two or more conditions (e.g., maintaining an average speed at least 10 mph below the speed limit while driving in rain), the driving analysis and vehicle pricing module 214 may create a subset of vehicle performance and condition data analysis results corresponding to periods of rain, and compute an average speed for the subset of vehicle performance and condition data analysis results.

In step 304, one or more vehicle grades and/or resale prices may be calculated and/or adjusted based on the driving behaviors determined in step 303 and vehicle performance and condition data received in step 301. As discussed above, vehicle grades and/or resale prices may correspond to ratings by insurance companies, financial institutions, or other organizations of the driving behavior history (based on vehicle driving data), vehicle maintenance history, insurance record (e.g., vehicle accident and/or claim history) and other vehicle information of a vehicle 210. Vehicle grades may be used to help obtain vehicle financing, calculate vehicle resale prices and determine insurance, rates, coverage, and discounts. For example, a high vehicle grade for a vehicle may result in a lower interest finance rate for a buyer of the vehicle, because the vehicle is worth more than a vehicle with a low vehicle grade and/or because the vehicle is in better condition than a vehicle with a low vehicle grade. Similarly, a high vehicle grade for a vehicle may result in a lower interest finance rate for a leaser of the vehicle, because the vehicle is worth more than a vehicle with a low vehicle grade and/or because the vehicle is in better condition than a vehicle with a low vehicle grade. A first vehicle score calculated for a first vehicle owned by a first individual may be used by a second individual who is considering purchasing a second vehicle with the first individual. For example, a group of individuals may decide to purchase the second vehicle jointly. The second individual (part of the group of individuals) may evaluate the first vehicle score calculated for the first vehicle owned by the first individual (part of the group of individuals). Based on the first vehicle score, the second individual may decide whether or not to purchase the second vehicle with the first individual. The second individual may similarly evaluate vehicle scores for other individuals in the group of individuals to evaluate their suitability as co-purchasers of the second vehicle.

If driving analysis and vehicle pricing module 214 determines a “negative” (e.g., unsafe, risky or vehicle-damaging/wearing) driving behavior for a driver of vehicle 210 in step 303, then the driving analysis and vehicle pricing module 214 may negatively adjust the vehicle grades and/or resale prices in step 304. Likewise, if driving analysis and vehicle pricing module 214 determines that the vehicle driving data, including vehicle maintenance history and/or insurance claim history, of vehicle 210 indicates vehicle wear in step 303, then the driving analysis and vehicle pricing module 214 may negatively adjust the vehicle grades and/or resale prices in step 304. On the other hand, if the driving analysis and vehicle pricing module 214 determines a “positive” or safe driving behavior (e.g., limited occurrences of hard braking during a particular time period, maintaining a regular vehicle maintenance schedule, etc.) in step 303, then the driving analysis and vehicle pricing module 214 may positively adjust the vehicle grades and/or resale prices in step 304.

When calculating or adjusting vehicle grades and/or resale prices based on determined driving behaviors, vehicle maintenance history, driving record, and/or insurance claim history, behaviors, wear and/or claims of greater magnitude (e.g., chronic hard braking, severe tailgating, racing, chronic failure to maintain a regular maintenance schedule, several accidents/claims within a short period of time, etc.) may be weighed more heavily than less severe behaviors, wear and/or claims (e.g., minor tailgating, failure to yield to allow a lane change in traffic, a slightly overdue oil change, a single accident/claim within the insurance policy term, etc.). Additionally, minor driving behaviors, wear and/or claims might not cause any adjustments in vehicle grades and/or resale prices, and some positive and negative behaviors may cancel out so that the vehicle grades and/or resale prices might not be adjusted. In some cases, all occurrences of all determined positive and negative driving behaviors, wear and/or claims may be accumulated and stored over a period of time, such a week, month, year, or for an insurance policy term, and the accumulated set of driving behaviors, wear and/or claims may be used to calculate vehicle grades and/or resale prices, insurance rate adjustments and/or discounts. In certain embodiments, vehicle resale price is determined without calculation and/or consideration of a vehicle grade. In other embodiments, vehicle resale price is based on the calculated vehicle grade. For example, a particular vehicle grade/grade range (e.g., 1, 2, 3, 1-3, etc.) may correspond to a particular vehicle resale price/price range (e.g., $3,000, $3,500, $4,000, $4,500, $5,000, $3,000-$5,000, etc.) and/or vehicle resale price adjustment/adjustment range (e.g., a decrease of $500-$1,000, a decrease of $1000, decrease of $500, etc.). In further embodiments, vehicle resale price is based on the vehicle performance and condition data (e.g., telematics data) itself, without any calculation of driving behaviors or vehicle grade. For instance, if the analysis of the vehicle performance and condition data in step 303 demonstrates that the vehicle has worn belts, good tires and worn brakes, a vehicle resale price may be based on this vehicle performance and condition data alone, without any calculation of driving behaviors or vehicle grade. In some embodiments, each vehicle condition (worn belts, good tires and worn brakes, in this example) demonstrated by the vehicle performance and condition data may be assigned a particular resale price adjustment and the resale price may be adjusted accordingly in step 304. In certain embodiments, the particular resale price adjustment is additionally or alternatively based on the vehicle 210 make, model and year.

In certain embodiments, a baseline price may be received from, for example, an insurance provider, third party valuation service of the like, based on the make, model, year and general condition of vehicle 210. Where vehicle resale price is based on the vehicle performance and condition data (e.g., telematics data) itself, this baseline price may then be adjusted up or down by the driving analysis and vehicle pricing module 214 based on the vehicle performance and condition data itself. Where vehicle resale price is based on driving behaviors and/or maintenance data, the baseline price may be adjusted up or down by the driving analysis and vehicle pricing module 214 based on the vehicle driving data, determined driving behaviors and/or vehicle maintenance data.

For each driving behavior determined in step 303, the driving analysis and vehicle pricing module 214 may calculate a score (block 305) (e.g., a numerical value). Where the driving analysis and vehicle pricing module 214 determines in step 303 that the vehicle engaged in a particular driving behavior, the driving analysis and vehicle pricing module 214 may use a numerical value associated with that particular driving behavior in the driving data and vehicle grade and/or price database 252 as the score of the particular driving behavior. The driving analysis and vehicle pricing module 214 may adjust the score of the driving behavior based on a weight assigned to the driving behavior in the driving data and vehicle grade and/or price database 252 (block 306). Where the driving behavior is assigned a weight, the driving analysis and vehicle pricing module 214 may combine the score of the driving behavior with the weight of the driving behavior (e.g., by multiplying the weight and the numerical value) (block 307).

The driving analysis and vehicle pricing module 214 may repeat these method steps (blocks 305, 306 and 307) for all driving behaviors determined in step 303. As such, the driving analysis and vehicle pricing module 214 may calculate a score (weighted or non-weighted) for each driving behavior determined in step 303.

The driving analysis and vehicle pricing module 214 may apply a vehicle grade and/or resale price equation to the calculated scores (weighted or non-weighted) (block 309). In some examples, the vehicle grade and/or resale price equation may aggregate the scores for each driving behavior. An example of a vehicle grade and/or resale price equation may be:

vehicle grade and/or resale price=driving_behavior[1].score+driving_behavior[2].score+ . . . +driving_behavior[n].score

where driving_behavior[1].score . . . driving_behavior[n].score are the respective scores for each driving behavior determined in step 303. In some examples, the scores for each driving behavior may be weighted, as described above. Additionally or alternatively, the scores for each driving behavior may be weighted by the vehicle grade and/or resale price equation. An example of a vehicle grade and/or resale price equation with weights may be:

vehicle grade and/or resale price=(driving_behavior[1].score×weight[1])+(driving_behavior[2].score×weight[2])+ . . . +(driving_behavior[n].score×weight[n])

where weight[1] . . . weight[n] are the weights respectively associated with driving_behavior[1] . . . driving behavior[n].

It will be appreciated that additional or alternative mathematical operations may be selectively employed to aggregate the scores for each driving behavior determined in step 303. It will also be appreciated that the driving analysis and vehicle pricing module 214 may be configured to employ one or more vehicle grade and/or resale price equations that respectively aggregate different driving behaviors.

In step 310, the driving analysis and vehicle pricing module 214 determines whether or not the vehicle grade and/or resale price determined in step 304 is within a predetermined threshold for the particular make, model and year of vehicle 210 (e.g., a particular grade and/or price or a grade and/or price range) stored in the driving data and vehicle grade and/or price database 252. In certain instances, the predetermined threshold may be a grade (e.g., “A,” “5,” etc.) or grade range (e.g., “A+ through B,” “5 through 3.5,” etc.). In other aspects, the predetermined threshold may be a resale price (e.g., $5,000, $10,000, etc.) or resale price range (e.g., $5,000-$10,000). In further embodiments, the predetermined threshold may be a combination of a grade and a resale price (e.g., $10,000 if the vehicle grade is an “A,” $5,000 if the vehicle grade is a “B,” etc.), combination of a grade range and a resale price (e.g., $10,000 if the vehicle grade is an “A+ through B,” etc.), combination of a grade and a resale price range (e.g., $5,000-$10,000 if the vehicle grade is an “A,” etc.), or combination of a grade range and resale price range (e.g., $5,000-$10,000 if the vehicle grade is an “A+ through B,” etc.). If the vehicle grade and/or resale price determined in step 304 is within the predetermined threshold, a consumer purchases the vehicle 210 (step 311). If the vehicle grade and/or resale price determined in step 304 is outside the predetermined threshold, the consumer does not purchase the vehicle 210 (step 312). Alternatively, if the vehicle grade and/or resale price determined in step 304 is within the predetermined threshold, a consumer may purchase the vehicle 210 at a first price. If the vehicle grade and/or resale price determined in step 304 is outside the predetermined threshold, the consumer may purchase the vehicle at a second price. The second price may be lower than the first vehicle. Therefore, a potential buyer of the vehicle may access the vehicle grade score and use the vehicle grade score to determine an appropriate purchase price for the vehicle.

As shown in FIG. 3, a single vehicle-based driving analysis and vehicle pricing module 214 may receive driving data for a vehicle 210 (step 301), may determine driving behaviors (step 303), may calculate or update vehicle grades and/or resale prices (step 304) for the vehicle 210, and may determine whether or not the vehicle grade and/or resale price determined in step 304 meets or exceeds a predetermined threshold value (step 310). However, other driving analysis and vehicle pricing modules and/or other computing devices may be used to execute some or all of the steps and functionality described above in reference to FIG. 3. For example, any of steps 301-312 may be performed by a user's mobile device 215 within the vehicle 210. The mobile device 215 or another computing device 230, may execute software configured to perform similar functionality in place of the driving analysis and vehicle pricing module 214. Additionally, some or all of the driving analysis and vehicle pricing functionality described in reference to FIG. 3 may be performed by a driving analysis and vehicle pricing module 251 at a non-vehicle based driving analysis and vehicle pricing server 250. For example, vehicle 210 may be configured to transmit its own vehicle sensor data to a central driving analysis and vehicle pricing server 250 via telematics device 213. In this example, the driving analysis and vehicle pricing module 251 of the server 250 may perform the data analysis, determinations of driving behaviors, vehicle grade and/or resale price calculations, and predetermined threshold determinations for any vehicle 210 for which it receives driving data.

In some examples, certain functionality may be performed in vehicle-based driving analysis and vehicle pricing module 214, while other functionality may be performed by the driving analysis and vehicle pricing module 251 at the driving analysis and vehicle pricing server 250. For instance, vehicle-based driving analysis and vehicle pricing module 214 may continuously receive and analyze driving data for its own vehicle 210, and may determine driving behaviors (e.g., speeding, hard braking, swerving, etc.) for its own vehicle 210. After the vehicle-based driving analysis and vehicle pricing module 214 has determined the driving behaviors, indications of these behaviors may be transmitted to the server 250 so that the driving analysis and vehicle pricing module 251 can perform the vehicle grade and/or resale price calculations and updates based on the driving behaviors and vehicle driving data. For instance, vehicle 210 may detect a negative driving behavior for another vehicle, and may report the negative behavior for the other vehicle to the driving analysis and vehicle pricing server 250, which may access other vehicle and driver information for the other vehicle and may potentially adjust a vehicle grade and/or resale price for the other vehicle based on the driving behaviors reported by vehicle 210. Additionally, in some embodiments, any analysis that might be performed at the driving analysis and vehicle pricing server 250 may be performed instead within the vehicles, for example, in driving analysis and vehicle pricing module 214. Thus, the driving analysis and vehicle pricing server 250 may be optional in certain embodiments, and some or all of the driving analyses may be performed within the vehicles themselves.

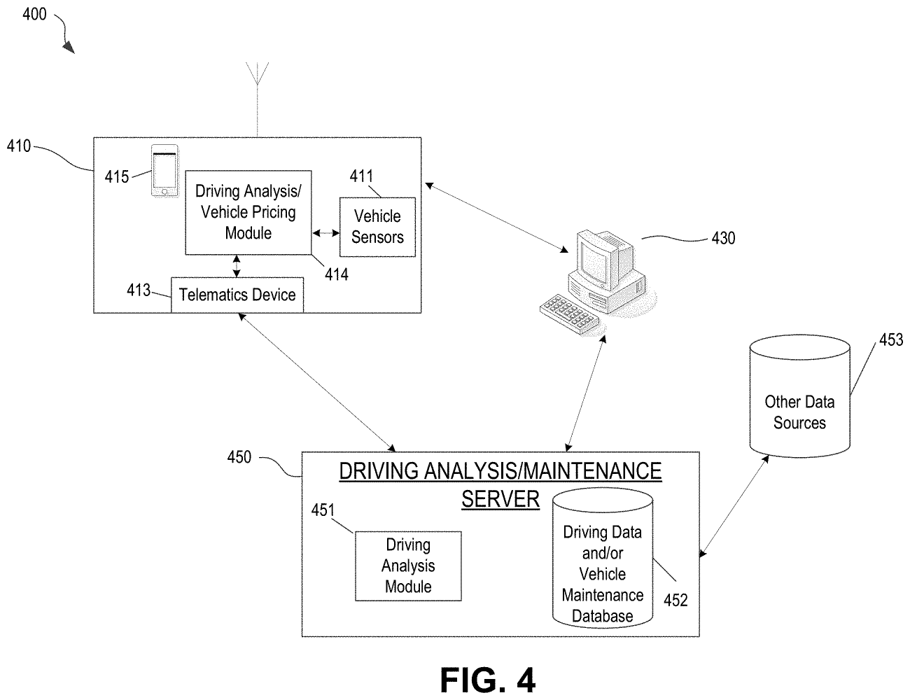

FIG. 4 is a diagram of an illustrative driving analysis and vehicle maintenance system 400 including a vehicle 410, a driving analysis and vehicle maintenance server 450, and additional related components. Each component shown in FIG. 4 may be implemented in hardware, software, or a combination of the two. Additionally, each component of the driving analysis and vehicle maintenance system 400 may include a computing device (or system) having some or all of the structural components described above for computing device 101 and driving analysis and vehicle pricing system 200.

Vehicle 410 in the driving analysis and vehicle maintenance system 400 is analogous to vehicle 210 discussed above and thus, all discussion of vehicle 210 also applies here to vehicle 410. The vehicle 410 includes vehicle operation sensors 411 capable of detecting and recording various conditions at the vehicle and operational parameters of the vehicle 410. Vehicle sensors 411 in the driving analysis and vehicle maintenance system 400 are analogous or similar to vehicle sensors 211 discussed above and thus, all discussion of vehicle sensors 211 also applies here to vehicle sensors 411. The data collected by vehicle sensors 411 may be stored and/or analyzed within the respective vehicle 410, and/or may be transmitted to one or more external devices. For example, as shown in FIG. 4, sensor data may be transmitted via a telematics device 413 to one or more remote computing devices, such as driving analysis and vehicle maintenance server 450. Vehicle maintenance server 450 in the driving analysis and vehicle maintenance system 400 is analogous to vehicle maintenance server 250 discussed above and thus, all discussion of vehicle maintenance server 250 also applies here to vehicle maintenance server 450.

As shown in FIG. 4, the data collected by vehicle sensors 411 may be transmitted to a driving analysis and vehicle maintenance server 450, and one or more additional external servers and devices via a telematics device 413. Telematics device 413 may be a computing device containing many or all of the hardware/software components as the computing device 101 depicted in FIG. 1. As discussed above, the telematics device 413 may receive vehicle operation data and driving data from vehicle sensors 411, and may transmit the data to one or more external computer systems (e.g., driving analysis and vehicle maintenance server 450 of an insurance provider, financial institution, or other entity) over a wireless transmission network. Telematics device 413 in the driving analysis and vehicle maintenance system 400 is analogous to telematics device 213 discussed above and thus, all discussion of telematics device 213 also applies here to telematics device 413.

In certain embodiments, mobile computing device 415 within the vehicle 410 may be used to collect vehicle performance and condition data and/or to receive vehicle performance and condition data from sensors 411, and then to transmit the vehicle performance and condition data to the driving analysis and vehicle maintenance server 450 and other external computing devices. Mobile computing device 415 in the driving analysis and vehicle maintenance system 400 is analogous to mobile computing device 215 discussed above and thus, all discussion of mobile computing device 215 also applies here to mobile computing device 415. When mobile computing device 415 within the vehicle 410 is used to detect vehicle performance and condition data and/or to receive vehicle performance and condition data from vehicle sensors 411, the mobile computing device 415 may store, analyze, and/or transmit the vehicle performance and condition data to one or more other devices. For example, mobile computing device 415 may transmit vehicle performance and condition data directly to one or more driving analysis and vehicle maintenance servers 450, and thus may be used in conjunction with or instead of telematics device 413. Moreover, the processing components of the mobile computing device 415 may be used to analyze vehicle driving data, determine driving behaviors, determine a need for vehicle maintenance, calculate vehicle grades and/or resale prices, and perform other related functions. Therefore, in certain embodiments, mobile computing device 415 may be used in conjunction with, or in place of, the driving analysis and vehicle pricing module 414.

Vehicle 410 may include driving analysis and vehicle pricing module 414, which may be a separate computing device or may be integrated into one or more other components within the vehicle 410, such as the telematics device 413, or the internal computing systems of vehicle 410. Vehicle pricing module 414 in the driving analysis and vehicle maintenance system 400 is analogous to vehicle pricing module 214 discussed above and thus, all discussion of vehicle pricing module 214 also applies here to vehicle pricing module 414. In some embodiments, vehicle 410 does not include a driving analysis and vehicle pricing module 414. As discussed above, driving analysis and vehicle pricing module 414 also may be implemented by computing devices independent from the vehicle 410, such as mobile computing device 415 of the drivers or passengers, or one or more separate computer systems 430 (e.g., a user's home or office computer). In any of these examples, the driving analysis and vehicle pricing module 414 may contain some or all of the hardware/software components of the telematics device 101 depicted in FIG. 1. Further, in certain implementations, the functionality of the driving analysis and vehicle pricing module 414, such as storing and analyzing vehicle driving data, determining driving behaviors, determining whether maintenance is necessary, and calculating vehicle grades and/or resale prices, may be performed in a central driving analysis and vehicle maintenance server 450 rather than by the vehicle 410. In such implementations, the vehicle 410 might only collect and transmit vehicle performance and condition data to a driving analysis and vehicle maintenance server 450, and thus the vehicle-based driving analysis and vehicle pricing module 414 may be optional.

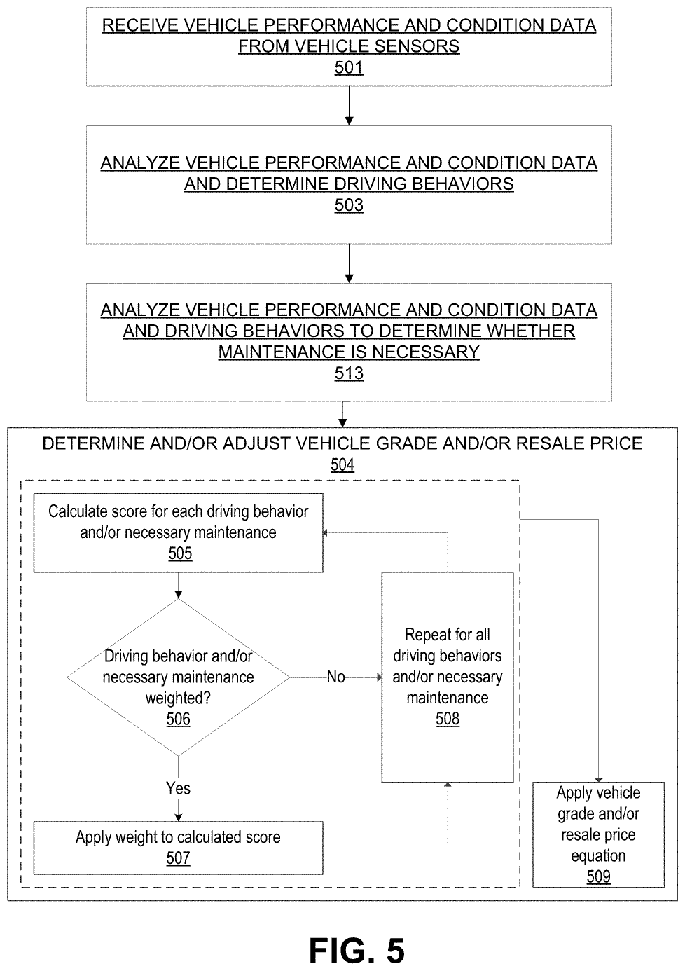

Driving analysis and vehicle pricing module 414 may be implemented in hardware and/or software configured to receive vehicle performance and condition data from vehicle sensors 411, telematics device 413, and/or other driving data sources. After receiving the vehicle driving data, driving analysis and vehicle pricing module 414 may perform a set of functions to analyze the driving data, determine driving behaviors, determine the need for maintenance, and calculate vehicle grades and/or prices. For example, the driving analysis and vehicle pricing module 414 may include one or more driving behavior analysis, vehicle maintenance, vehicle grade and/or vehicle price calculation algorithms, which may be executed by software running on generic or specialized hardware within the driving analysis and vehicle pricing module 414. The driving analysis and vehicle pricing module 414 in vehicle 410 may use the vehicle performance and condition data received from that vehicle's sensors 411 to determine driving behaviors, determine the need for maintenance and determine and/or adjust vehicle grades and/or prices applicable to vehicle 410. Within the driving analysis and vehicle pricing module 414, a vehicle grade/price calculation function may use the results of the driving analysis, maintenance analysis and vehicle pricing performed by the module 414 to calculate/adjust vehicle grades and/or prices for vehicle 410. Further descriptions and examples of the algorithms, functions, and analyses that may be executed by the driving analysis and vehicle pricing module 414 are described below in reference to FIG. 5.

The system 400 also may include a driving analysis and vehicle maintenance server 450, containing some or all of the hardware/software components as the computing device 101 depicted in FIG. 1. The driving analysis and vehicle maintenance server 450 may include hardware, software, and network components to receive vehicle performance and condition data from one or more vehicles 410, and other data sources 453. The driving analysis and vehicle maintenance server 450 may include a driving data and/or vehicle maintenance database 452 and driving analysis and vehicle pricing module 451 to respectively store and analyze driving data received from vehicles and other data sources 453 (e.g., insurance records, including policy information, vehicle accident and/or claim history, etc.; vehicle maintenance records; driving records; etc.). The driving analysis and vehicle maintenance server 450 may initiate communication with and/or retrieve driving data from vehicle 410 wirelessly via telematics device 413, mobile device 415, or by way of separate computing systems (e.g., computer 430) over one or more computer networks (e.g., the Internet). Additionally, the driving analysis and vehicle maintenance server 450 may receive additional data relevant to driving behavior determinations, maintenance determinations and vehicle grade/price calculations from other non-vehicle data sources, such as external traffic databases containing traffic data (e.g., amounts of traffic, average driving speed, traffic speed distribution, and numbers and types of accidents, etc.) at various times and locations, external weather databases containing weather data (e.g., rain, snow, sleet, and hail amounts, temperatures, wind, road conditions, visibility, etc.) at various times and locations, and other external data sources containing driving hazard data (e.g., road hazards, traffic accidents, downed trees, power outages, road construction zones, school zones, and natural disasters, etc.), as well as expected maintenance data (e.g., type of maintenance, expected number of miles at which maintenance should be performed, etc.).

Data stored in the driving data and vehicle grade and/or price database 452 may be organized in any of several different manners. For example, a table in driving data and/or vehicle maintenance database 452 may contain all of the vehicle operation data for a specific vehicle 410, similar to a vehicle event log. Other tables in the driving data and/or vehicle maintenance database 452 may store certain types of data for multiple vehicles. For instance, tables may store specific driving behaviors and interactions (e.g., accidents, tailgating, cutting-off, yielding, racing, defensive avoidances, etc.) for multiples vehicles. Vehicle performance and condition data may also be organized by time and/or place, so that the driving behaviors or interactions between multiples vehicle may be stored or grouped by time and location.

The driving analysis and vehicle pricing module 451 within the driving analysis and vehicle maintenance server 450 may be configured to retrieve data from the driving data and/or vehicle maintenance database 452, or may receive driving data directly from vehicle 410 or other data sources 453, and may perform driving data analyses, driving behavior determinations, vehicle grade and/or price calculations, and other related functions. The functions performed by the driving analysis and vehicle pricing module 451 may be similar to those of driving analysis and vehicle pricing module 414, and further descriptions and examples of the algorithms, functions, and analyses that may be executed by the driving analysis and vehicle pricing module 451 are described below in reference to FIG. 5.

In various examples, the driving data analyses, maintenance determinations, driving behavior determinations, and vehicle grade and/or price calculations may be performed entirely in the driving analysis and vehicle pricing module 451 of the driving analysis and vehicle maintenance server 450 (in which case driving analysis and vehicle pricing module 414 might not be implemented in vehicle 410), or may be performed entirely in the vehicle-based driving analysis and vehicle pricing module 414 (in which case the driving analysis and vehicle pricing module 451 and/or the driving analysis and vehicle maintenance server 450 might not be implemented). In other examples, certain driving data analyses may be performed by vehicle-based driving analysis and vehicle pricing module 414, while other driving data analyses are performed by the driving analysis and vehicle pricing module 451 at the driving analysis and vehicle maintenance server 450. For example, a vehicle-based driving analysis and vehicle pricing module 414 may continuously receive and analyze driving data from nearby vehicles to determine certain driving behaviors (e.g., tailgating, cutting-off, yielding, etc.) so that large amounts of driving data need not be transmitted to the driving analysis and vehicle maintenance server 450. However, after a positive or negative driving behavior is determined by the vehicle-based driving analysis and vehicle pricing module 214, the behavior may be transmitted to the server 450, and the driving analysis and vehicle pricing module 451 may determine if vehicle maintenance is necessary and/or if a vehicle grade and/or price calculation should be updated based on the determined driving behavior and vehicle driving data.

FIG. 5 is a flow diagram illustrating an example method of performing driving behavior determinations, maintenance determinations and vehicle grade and/or price calculations based on analyses of vehicle performance and condition data received from, for example, vehicle sensors 411 and/or telematics device 413. This example method may be performed by one or more computing devices in a driving analysis and vehicle maintenance system, such as vehicle-based driving analysis and vehicle pricing module 414, a driving analysis and vehicle pricing module 451 of a driving analysis and vehicle maintenance server 450, user mobile computing device 415, and/or other computer systems.

The steps shown in FIG. 5 describe performing an analysis to determine driving behaviors of vehicle 410, determining whether maintenance is necessary based on vehicle performance and condition data and the determined driving behaviors, and calculating or adjusting vehicle 210 grades and/or resale prices based on the determined driving behaviors, vehicle maintenance determination and/or vehicle driving data. As described above in reference to FIG. 4, the vehicle 410 may or may not be an insurance provider customer and/or may or may not be a subscriber to the insurance provider's telematics program. In some embodiments, the vehicle 410 is a customer of the insurance provider and a subscriber to the insurance provider's telematics program. In other variations, the vehicle 410 is a subscriber to the insurance company's telematics program and/or not a customer of the insurance provider. Driving behaviors are defined as described above. Additionally, occurrences of negative driving behaviors may indicate a potential need for maintenance, while occurrences of positive driving behaviors may indicate scheduled maintenance may be delayed.

In step 501, vehicle performance and condition data may be received for a vehicle 410, corresponding to data from the vehicle's sensors 411, vehicle maintenance record databases, insurance record databases, external weather databases, external traffic databases, external driving hazards database and/or other vehicle data indicative of vehicle value. As described above in reference to FIG. 4, a driving analysis and vehicle pricing module 414 within vehicle 410 may receive and store vehicle performance and condition data from the vehicle's internal computer systems and any combination of the vehicle's sensors 411. The data received in step 501 may include, for example, the data received in step 301.

In step 503, the vehicle performance and condition data received in step 501 may be analyzed, and driving behaviors indicative of the condition of the vehicle may be determined for the vehicle 410 based on the driving data. The above discussion with respect to step 303 applies to step 503 and is incorporated here. The driving analysis and vehicle pricing module 414 may first determine whether a particular driving behavior was exhibited in the vehicle performance and condition data analysis results. For example, where a driving behavior is based on maintaining an average speed below 50 mph during a trip, the driving analysis and vehicle pricing module 414 may determine whether the vehicle performance and condition data analysis results for a particular trip reflected an average speed below 50 mph by comparing the average speed of the trip with the 50 mph limit. In some examples, the vehicle performance and condition data analysis results may include overall trip metrics (e.g., minimum/maximum/average speed, number of hard brakes, total miles traveled, etc.), such that the driving analysis and vehicle pricing module 414 may compare the metrics to the requirements of a particular driving behavior. However, in other examples, the driving analysis and vehicle pricing module 414 may need to derive one or more trip metrics in order to make a determination as to whether a user engaged in a particular driving behavior. For example, where a driving behavior involves two or more conditions (e.g., maintaining an average speed at least 10 mph below the speed limit while driving in rain), the driving analysis and vehicle pricing module 414 may create a subset of vehicle performance and condition data analysis results corresponding to periods of rain, and compute an average speed for the subset of vehicle performance and condition data analysis results.

In step 513, the driving analysis and vehicle pricing module 414 may analyze the vehicle performance and condition data received in step 501 and the driving behaviors determined in step 503 in order to determine whether or not maintenance is necessary. For example, if the vehicle performance and condition data and/or driving behaviors indicate a history of chronic hard braking and brake wear, it may be recommended to have the brakes replaced sooner than if no or limited hard braking occurs or if limited wear is detected. In certain instances, the driving analysis and vehicle pricing module 414 may determine that vehicle maintenance is necessary or recommended prior to scheduled maintenance (e.g., based on received driving data, driving behaviors, and the like). In other instances, the driving analysis and vehicle pricing module 414 may determine that vehicle maintenance is not necessary or recommended until after scheduled maintenance (e.g., based on receiving driving data, driving behaviors, and the like). In some examples, the driving analysis and vehicle pricing module 414 may determine that no vehicle maintenance is necessary or recommended at that time. When the driving analysis and vehicle pricing module 414 determines that maintenance is necessary or recommended, the driving analysis and vehicle pricing module 414 may then determine and provide to the user (e.g., via a graphical user interface) a suggested time period in which the maintenance should be completed.

In step 504, one or more vehicle grades and/or resale prices may be calculated and/or adjusted based on the driving behaviors determined in step 503, necessary or recommended maintenance determined in step 513 and vehicle performance and condition data received in step 501. The discussion of vehicle grades and/or resale prices discussed above with respect to step 304 applies to step 504 and is incorporated here.

In certain embodiments, a baseline price may be received from, for example, an insurance provider, third party valuation service of the like, based on the make, model, year and general condition of vehicle 410. Where vehicle resale price is based on the vehicle performance and condition data (e.g., telematics data) itself, this baseline price may then be adjusted up or down by the driving analysis and vehicle pricing module 414 based on the vehicle performance and condition data itself. Where vehicle resale price is based on driving behaviors, maintenance data and/or recommended maintenance, the baseline price may be adjusted up or down by the driving analysis and vehicle pricing module 414 based on the vehicle driving data, determined driving behaviors, vehicle maintenance data and/or recommended maintenance.

For each driving behavior determined in step 503 and/or each necessary or recommended maintenance determined in step 513, the driving analysis and vehicle pricing module 414 may calculate a score (block 505) (e.g., a numerical value). Where the driving analysis and vehicle pricing module 414 determines in step 503 that the vehicle engaged in a particular driving behavior, the driving analysis and vehicle pricing module 414 may use a numerical value associated with that particular driving behavior in the driving data and/or vehicle maintenance database 452 as the score of the particular driving behavior. The driving analysis and vehicle pricing module 414 may adjust the score of the driving behavior based on a weight assigned to the driving behavior in the driving data and/or vehicle maintenance database 452 (block 506). Where the driving behavior is assigned a weight, the driving analysis and vehicle pricing module 414 may combine the score of the driving behavior with the weight of the driving behavior (e.g., by multiplying the weight and the numerical value) (block 507). Where the driving analysis and vehicle pricing module 414 determines in step 513 that the vehicle is in need of or is recommended to have maintenance performed, the driving analysis and vehicle pricing module 414 may use a numerical value associated with that particular maintenance in the driving data and/or vehicle maintenance database 452 as the score of the particular maintenance. The driving analysis and vehicle pricing module 414 may adjust the score of the maintenance based on a weight assigned to the maintenance in the driving data and/or vehicle maintenance database 452 (block 506). For instance, replacement of brakes may be weighted more heavily than replacement of, for instance, windshield wipers (e.g., maintenance may be prioritized by safety, wear on the part, or the like, and may be weighted accordingly). Where the maintenance is assigned a weight, the driving analysis and vehicle pricing module 414 may combine the score of the maintenance with the weight of the maintenance (e.g., by multiplying the weight and the numerical value) (block 507).

The driving analysis and vehicle pricing module 414 may repeat these method steps (blocks 505, 506 and 507) for all driving behaviors determined in step 503 and all necessary maintenance determined in step 513. As such, the driving analysis and vehicle pricing module 414 may calculate a score (weighted or non-weighted) for each driving behavior determined in step 503 and for each necessary maintenance determined in step 513.

The driving analysis and vehicle pricing module 414 may apply a vehicle grade and/or resale price equation to the calculated scores (weighted or non-weighted) (block 509). The discussion of vehicle grade and/or resale price equations with respect to step 304 (e.g., block 309) above applies to step 504 (e.g., block 509) and is incorporated here. It will be appreciated that additional or alternative mathematical operations may be selectively employed to aggregate the scores for each necessary maintenance determined in step 513.

As shown in FIG. 5, a single vehicle-based driving analysis and vehicle pricing module 414 may receive driving data for a vehicle 410 (step 501), may determine driving behaviors (step 503), may determine whether vehicle maintenance is necessary (step 513) and may calculate or update vehicle grades and/or resale prices (step 304) for the vehicle 410. However, other driving analysis, vehicle maintenance and vehicle pricing modules and/or other computing devices may be used to execute some or all of the steps and functionality described above in reference to FIG. 5. For example, any of steps 501-509 may be performed by a user's mobile device 415 within the vehicle 410. The mobile device 415 or another computing device 430, may execute software configured to perform similar functionality in place of the driving analysis and vehicle pricing module 414. Additionally, some or all of the driving analysis and vehicle pricing functionality described in reference to FIG. 5 may be performed by a driving analysis and vehicle pricing module 451 at a non-vehicle based driving analysis and vehicle maintenance server 450. For example, vehicle 410 may be configured to transmit its own vehicle sensor data to a central driving analysis and vehicle maintenance server 450 via telematics device 413. In this example, the driving analysis and vehicle pricing module 451 of the server 450 may perform the data analysis, determinations of driving behaviors, maintenance determination, and vehicle grade and/or resale price calculations for any vehicle 410 for which it receives driving data.

In some examples, certain functionality may be performed in vehicle-based driving analysis and vehicle pricing module 414, while other functionality may be performed by the driving analysis and vehicle pricing module 451 at the driving analysis and vehicle maintenance server 450. For instance, vehicle-based driving analysis and vehicle pricing module 414 may continuously receive and analyze driving data for its own vehicle 410, may determine driving behaviors (e.g., speeding, hard braking, swerving, etc.) for its own vehicle 410, and may determine necessary maintenance for its own vehicle 410. After the vehicle-based driving analysis and vehicle pricing module 414 has determined the driving behaviors, indications of these behaviors may be transmitted to the server 450 so that the driving analysis and vehicle pricing module 451 can perform the maintenance determination and vehicle grade and/or resale price calculations and updates based on the driving behaviors and vehicle driving data. For instance, vehicle 410 may detect a negative driving behavior for another vehicle, and may report the negative behavior for the other vehicle to the driving analysis and vehicle maintenance server 450, which may access other vehicle and driver information for the other vehicle and may potentially adjust a vehicle grade and/or resale price for the other vehicle based on the driving behaviors reported by vehicle 410. Additionally, in some embodiments, any analysis that might be performed at the driving analysis and vehicle maintenance server 450 may be performed instead within the vehicles, for example, in driving analysis and vehicle pricing module 414. Thus, the driving analysis and vehicle maintenance server 450 may be optional in certain embodiments, and some or all of the driving analyses may be performed within the vehicles themselves.

The following are some example implementations of the systems and arrangements described herein. They are intended to be just some example implementations and are not intended to limit the systems described herein to only the examples provided.

In one example, User A is a customer of an insurance provider and a subscriber to the insurance provider's telematics program. User A wants to sell his car (e.g. Vehicle A) and decides to use a driving analysis and vehicle pricing mobile application downloaded and running on his mobile device to evaluate the vehicle performance and condition data of his car and determine a resale price. Upon launching, the driving analysis and vehicle pricing mobile application receives vehicle performance and condition data from Vehicle A which had been collected over the lifetime of Vehicle A. In some examples, a baseline resale value of the vehicle may be determined based on make, model, year, etc. of the vehicle. This may be determined based on historical resale value data (e.g., as collected, for instance, by an insurance provider), from a third party source, or from the driving data of the vehicle (e.g., number of miles, general condition, etc.).

The driving analysis and vehicle pricing mobile application analyzes the received driving data and identifies various user behaviors, such as that User A has a history of chronic hard braking, driving in areas of heavy snow fall and maintaining a regular vehicle maintenance schedule. As repeated hard braking causes brakes to wear faster than without hard braking, the driving analysis and vehicle pricing mobile application reduces the resale price of Vehicle A by $500. Similarly, as areas of heavy snow often salt their roads and salt causes vehicle corrosion, the driving analysis and vehicle pricing mobile application reduces the resale price of Vehicle A by $1,000. As maintaining a regular vehicle maintenance schedule generally optimizes vehicle condition, the driving analysis and vehicle pricing mobile application increases the resale price of Vehicle A by $500.

In another example, User B is a customer of an insurance provider and a subscriber to the insurance provider's telematics program. User B wants to sell his car (e.g. Vehicle B) and decides to use a driving analysis and vehicle pricing mobile application downloaded and running on his mobile device to evaluate the vehicle performance and condition data of his car and determine a resale price. Upon launching, the driving analysis and vehicle pricing mobile application receives vehicle performance and condition data from Vehicle B which had been collected over the past 5 years. The driving analysis and vehicle pricing mobile application analyzes the received driving data and identifies that User B occasionally speeds, was late on obtaining an oil change for Vehicle B on a few occasions, and was involved in one minor accident with Vehicle B. As none of the behaviors identified by the driving analysis and vehicle pricing mobile application were very serious or chronic, the driving analysis and vehicle pricing mobile application determines that no grade and/or resale price adjustment are needed, and maintains a vehicle grade of “B” and price range of $4,500-$5,000 for Vehicle B. Satisfied with the vehicle grade and price range, User B prompts the driving analysis and vehicle pricing mobile application to determine whether or not the vehicle grade and price range are within his insurance provider's threshold for the particular make, model and year of Vehicle B. The driving analysis and vehicle pricing mobile application determines the vehicle grade and price range are within the insurance provider's threshold for the particular make, model and year of Vehicle B, and the insurance provider agrees to purchase Vehicle B.

In another example, User C is a customer of an insurance provider and a subscriber to the insurance provider's telematics program. User C has a driving analysis and vehicle maintenance mobile application downloaded and running on his mobile device. Upon launching, the driving analysis and vehicle maintenance mobile application receives vehicle performance and condition data from Vehicle C (User C's car) which had been collected over the past year. The driving analysis and vehicle maintenance mobile application analyzes the received driving data and identifies that User C has repeatedly hard braked in the past year. As repeated hard braking causes brakes to wear faster than without hard braking, the driving analysis and vehicle maintenance mobile application determines that maintenance is necessary or recommended (e.g., replace brakes) and sends User C an alert on his mobile device indicating that Vehicle C will need new brakes before the date recommended by the manufacturer of Vehicle C and suggesting a time period in which the maintenance should be completed. Any suggested resale value of the vehicle may then be adjusted based on the recommended maintenance.

In another example, User D is a customer of an insurance provider and a subscriber to the insurance provider's telematics program. User D has a driving analysis and vehicle pricing/maintenance mobile application downloaded and running on his mobile device.

Upon launching, the driving analysis and vehicle pricing/maintenance mobile application receives vehicle performance and condition data from Vehicle D (User D's car) which had been collected over the lifetime of the vehicle. The driving analysis and vehicle pricing/maintenance mobile application analyzes the received driving data and identifies that User D has repeatedly hard braked over the lifetime of the vehicle. As repeated hard braking causes brakes to wear faster than without hard braking, the driving analysis and vehicle pricing/maintenance mobile application determines that maintenance is necessary and sends User D an alert on his mobile device indicating that Vehicle D will need new brakes before the date recommended by the manufacturer of Vehicle D and suggesting a time period in which the maintenance should be completed. User D decides to sell Vehicle D before the suggested maintenance time period expires without completing the maintenance. The driving analysis and vehicle pricing/maintenance mobile application uses the suggested maintenance and vehicle performance and condition data of Vehicle D to determine a resale price. As repeated hard braking causes brakes to wear faster than without hard braking, the driving analysis and vehicle pricing/maintenance mobile application reduces the resale price of Vehicle D by $500.

The various embodiments are not to be limited in scope by the specific embodiments disclosed in the examples. While the disclosure has been described with respect to specific examples including presently illustrative modes of carrying out the disclosure, a person having ordinary skill in the art, after review of the entirety disclosed herein, will appreciate that there are numerous variations and permutations of the above-described systems, methods and techniques that fall within the spirit and scope of the disclosure.

Where systems are described herein as having, including, or comprising specific components, or where processes are described herein as having, including, or comprising specific process steps, it is contemplated that the systems of the various embodiments can also consist essentially of, or consist of, the recited components, and that the processes of the various embodiments also consist essentially of, or consist of, the recited process steps.

It is noted that, as used herein and in the appended claims, the singular forms “a,” “an,” and “the” include plural references unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation.

Each of the individual embodiments described and illustrated herein has discrete components and features which may be readily separated from or combined with the features of any of the other several embodiments without departing from the scope or spirit of the disclosure. Any recited method can be carried out in the order of events recited or in any other order which is logically possible.

1. A system, comprising:
a plurality of vehicle operation sensors arranged on a vehicle and configured to monitor operation of the vehicle; and
a driving data analysis and vehicle pricing server comprising:
a processor; and
at least one memory storing computer-executable instructions, which when executed by the processor, cause the driving data analysis and vehicle pricing server to:
receive a baseline resale price of the vehicle;
receive vehicle driving data from the plurality of vehicle operation sensors, the vehicle driving data corresponding to vehicle operation data of the vehicle;
determine a first driving behavior associated with the vehicle, based on an analysis of the vehicle driving data;
receive, from a second vehicle, a second driving behavior associated with the vehicle;
determine a first weight for the first driving behavior and a second weight for the second driving behavior;
adjust the baseline resale price for the vehicle based on the first driving behavior, the second driving behavior, the first weight, the second weight, and the vehicle driving data;
determine a maintenance action associated with the vehicle;
send an alert to a mobile device of a user associated with the vehicle, the alert comprising the maintenance action and a suggested time period for completing the maintenance action;
receive, from a database, a weight for the maintenance action; and
re-adjust the baseline resale price based on the maintenance action and the weight for the maintenance action.

2. The system of claim 1, wherein the vehicle driving data is selected from the group consisting of engine speed, rate of acceleration, rate of deceleration, road conditions, locations that the vehicle has traveled, vehicle inspection histories, vehicle maintenance histories, average braking times, and combinations thereof.

3. The system of claim 1, wherein the maintenance action is determined based on vehicle driving data received from the plurality of vehicle operation sensors over a lifetime of the vehicle.

4. The system of claim 1, wherein the maintenance action is determined based on vehicle driving data collected by the plurality of vehicle operation sensors over a predetermined period of time.

5. The system of claim 1, wherein:
determining the first driving behavior associated with the vehicle comprises determining that the vehicle exceeded a maximum deceleration rate at least a minimum number of times within a predetermined period of time; and
adjusting the baseline resale price for the vehicle comprises reducing a vehicle price by a penalty amount.

6. The system of claim 1, wherein:
determining the first driving behavior associated with the vehicle comprises determining that the vehicle exceeded a maximum operation distance at least a minimum number of times within a predetermined period of time; and
adjusting the baseline resale price for the vehicle comprises reducing a vehicle price by a penalty amount.

7. The system of claim 1, wherein the at least one memory further stores computer-executable instructions, which when executed by the processor, cause the driving data analysis and vehicle pricing server to:
receive insurance provider vehicle price threshold data; and
determine whether the adjusted baseline resale price is within an insurance provider vehicle resale price threshold.

8. The system of claim 1, wherein the at least one memory further stores computer-executable instructions, which when executed by the processor, cause the driving data analysis and vehicle pricing server to:
receive vehicle driving data from a telematics device located within the vehicle.

9. A computer-implemented method, comprising:
receiving, by a driving analysis and vehicle pricing computing device, a baseline resale price of a vehicle;
receiving, by the driving analysis and vehicle pricing computing device, vehicle driving data corresponding to vehicle operation data of the vehicle, the vehicle operation data being received from a plurality of sensors arranged on the vehicle and configured to monitor operation of the vehicle;
determining, by the driving analysis and vehicle pricing computing device, a first driving behavior associated with the vehicle, based on an analysis of the vehicle driving data;
receiving, from a second vehicle, a second driving behavior associated with the vehicle
determining a first weight for the first driving behavior and a second weight for the second driving behavior;
adjusting the baseline resale price for the vehicle based on the first driving behavior, the second driving behavior, the first weight, the second weight, and the vehicle driving data;
determining a maintenance action associated with the vehicle;
sending an alert to a mobile device of a user associated with the vehicle, the alert comprising the maintenance action and a suggested time period for completing the maintenance action;
receiving, from a database, a weight for the maintenance action; and
re-adjusting the baseline resale price based on the maintenance action and the weight for the maintenance action.

10. The computer-implemented method of claim 9, wherein the vehicle driving data is selected from the group consisting of engine speed, rate of acceleration, rate of deceleration, road conditions, locations that the vehicle has traveled, vehicle inspection histories, vehicle maintenance histories, average braking times, and combinations thereof.

11. The computer-implemented method of claim 9, wherein:
determining the first driving behavior associated with the vehicle comprises determining that the vehicle exceeded a maximum deceleration rate at least a minimum number of times within a predetermined period of time; and
adjusting the baseline resale price for the vehicle comprises reducing a vehicle price by a penalty amount.

12. The computer-implemented method of claim 9, wherein:
determining the first driving behavior associated with the vehicle comprises determining that the vehicle exceeded a maximum operation distance at least a minimum number of times within a predetermined period of time; and
adjusting the baseline resale price for the vehicle comprises reducing a vehicle price by a penalty amount.

13. The computer-implemented method of claim 9, further comprising:
receiving, by the driving analysis and vehicle pricing computing device, vehicle resale price threshold data from an insurance provider server;
determining, by the driving analysis and vehicle pricing computing device, whether the re-adjusted baseline resale price is within an insurance provider vehicle resale price threshold; and
if the re-adjusted vehicle resale price is within the insurance provider vehicle resale price threshold, a consumer agreeing to purchase the vehicle.

14. A system, comprising:
a plurality of vehicle operation sensors arranged on a vehicle and configured to monitor operation of the vehicle; and
a driving data analysis and vehicle maintenance server comprising:
a processor; and
at least one memory storing computer-executable instructions, which when executed by the processor, cause the driving data analysis and vehicle maintenance server to:
receive a baseline resale price of the vehicle;
receive vehicle driving data from the plurality of vehicle operation sensors, the vehicle driving data corresponding to vehicle operation data of the vehicle;
determine a first driving behavior associated with the vehicle, based on an analysis of the vehicle driving data;
receive, from a second vehicle, a second driving behavior associated with the vehicle;
determine a first weight for the first driving behavior and a second weight for the second driving behavior;
adjust the baseline resale price for the vehicle based on the first driving behavior, the second driving behavior, the first weight, the second weight, and the vehicle driving data.

15. The system of claim 14, wherein the vehicle driving data is selected from the group consisting of engine speed, rate of acceleration, rate of deceleration, road conditions, locations that the vehicle has traveled, vehicle inspection histories, vehicle maintenance histories, average braking times, and combinations thereof.

16. The system of claim 14, wherein the recommended vehicle maintenance is determined based on vehicle driving data received from the plurality of vehicle operation sensors over a lifetime of the vehicle.

17. The system of claim 14, wherein the recommended vehicle maintenance is determined based on vehicle driving data collected by the plurality of vehicle operation sensors over a predetermined period of time.

18. The system of claim 14, wherein:
determining the first driving behavior associated with the vehicle comprises determining that the vehicle exceeded a maximum deceleration rate at least a minimum number of times within a predetermined period of time.

19. The system of claim 14, wherein:
determining the first driving behavior associated with the vehicle comprises determining that the vehicle exceeded a maximum operation distance at least a minimum number of times within a predetermined period of time.

20. The system of claim 14, wherein the at least one memory further stores computer-executable instructions, which when executed by the processor, cause the driving data analysis and vehicle maintenance server to:
provide a time period in which the recommended vehicle maintenance should be completed.
